(19) United States
(12) Patent Application Publication
(10) Pub. No.: US 2012/0319944 A1
(43) Pub. Date: Dec. 20, 2012

(54) CONTROL SYSTEM EQUIPPED WITH PROGRAMMABLE DISPLAY, PROGRAMMABLE DISPLAY, AND DRAWING DATA GENERATION MEANS

(75) Inventor: Kengo Koara, Tokyo (JP)

(73) Assignee: MITSUBISHI ELECTRIC CORPORATION, Tokyo (JP)

(21) Appl. No.: 13/581,643

(22) PCT Filed: Mar. 4, 2010
(86) PCT No.: PCT/JP2010/001514

§ 371 Date: Aug. 29, 2012

(51) Int. Cl. G09G 5/00

(52) U.S. Cl. 345/156

(57) ABSTRACT

A control system including, a programmable display, and an external device that is connected to the programmable display, wherein the external device stores specific display control information into a first device for each display designation information in correspondence with the display designation information; and wherein the programmable display includes a first memory block that stores the display designation information and all display-specific communication setting information, and a control block that makes an access to the first device of the external device according to the display designation information and the all display-specific communication setting information, to thus acquire its specific display control information corresponding to the display designation information, that stores the acquired specific display control information into a second memory block, and that controls the programmable display according to the specific display control information stored in the second memory block.

### TECHNICAL FIELD

The present invention relates to a control system equipped with a programmable display capable of sharing drawing data, a programmable display, and drawing data generation means thereof.

### BACKGROUND ART

In a related art control system including a plurality of programmable displays, when the majority of drawing data of each of the programmable displays are common and when some differences exist in the drawing data, there has been employed a method for generating the drawing data while dividing the data into a part common to all of the plurality of programmable displays and unique parts and separately managing the data, thereby making it possible to separately edit drawing data unique to each programmable display (see; for instance, Patent Document 1).

### RELATED ART DOCUMENT

### Patent Document

Patent Document 1: JP-A-H08-263244 (pg. 3, FIG. 3)

### DISCLOSURE OF THE INVENTION

### Problem that the Invention is to Solve

Since the related-art control system is configured as mentioned above, a problem pertaining to lateral spreading operation, which would arise when a change occurs in the common part of the drawing data, can be solved. However, in relation to the unique parts of the drawing data, pieces of drawing data that are as many as a number of the programmable displays are required. Accordingly, when the drawing data are individually changed and when the thus-changed drawing data are transferred to each of the programmable displays, the drawing data conforming to each programmable display to which the drawing data are to be transferred must be individually selected. This can be a cause of erroneous operation.

The present invention has been conceived to solve the problem, and an object of the invention is to provide a control system having programmable displays that can define operation of individual programmable displays with use of single common drawing data and can independently control the individual programmable displays even from the outside by preparing display designation information for designating individual programmable displays.

### Means for Solving the Problem

The control system of the present invention includes, a programmable display, and an external device that is connected to the programmable display by way of a communication channel and the programmable display reads and writes information from and in the external device, wherein the external device stores specific display control information, which is control information for controlling the programmable display, into a first device for each display designation information, in correspondence with the display designation information for specifying the programmable display connected to the communication channel; and wherein the programmable display includes a first memory block that stores the display designation information and all display-specific communication setting information for establishing a communication with the external device, and a control block that makes an access to the first device of the external device according to the display designation information and the all display-specific communication setting information, to thus acquire its specific display control information corresponding to the display designation information, that stores the acquired specific display control information into a second memory block, and that controls the programmable display according to the specific display control information stored in the second memory block.

### Advantage of the Invention

The present invention makes it possible to establish based on identical common drawing data a control system using a plurality of programmable displays that can be independently controlled by an external device. Therefore, when compared with the related-art method for generating individual drawing data conforming to the individual programmable displays, the present invention can prevent omission of lateral spreading of drawing data and also save power consumed by modifying drawing data.

### BRIEF DESCRIPTION OF THE DRAWINGS

FIG. 1 is a block diagram of a control system configured of a plurality of programmable displays showing a first embodiment of the present invention.

FIG. 2 is an internal block diagram of the programmable display of the first embodiment of the present invention.

FIG. 3 is a block diagram of information handled by the control system configured of the plurality of programmable displays showing the first embodiment of the present invention.

FIG. 4 is a view showing a method for setting display designation information about the programmable display showing the first embodiment of the present invention.

FIG. 5 shows processing procedures pertaining to screen switching control of specific display control information about the programmable display representing the first embodiment of the present invention.

FIG. 6 is an example back setting of the display designation information about the programmable display representing the first embodiment of the present invention.

FIG. 7 is an example setting of the display designation information about the programmable display representing the first embodiment of the present invention to a communication interface adaptor.

FIG. 8 shows example procedures of generating drawing data about the programmable display representing the first embodiment of the present invention.

FIG. 9 is an example setting screen of display number control definition information about a personal computer representing the first embodiment of the present invention.

FIG. 10 is an internal block diagram of a programmable display representing a second embodiment of the present invention.

### BEST MODES FOR IMPLEMENTING THE INVENTION

### First Embodiment

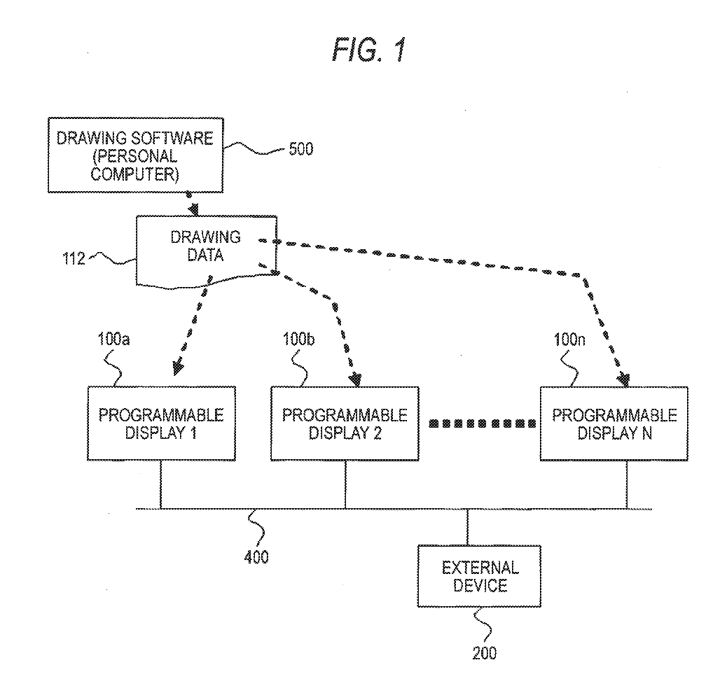

FIG. 1 is a block diagram of a control system configured of a plurality of programmable displays showing a first embodiment of the present invention. In FIG. 1, reference numerals 100a to 100n designate programmable displays, and 112 designates drawing data that specify operation of the programmable displays 100a to 100n. Reference numeral 200 designates an external device; for instance, a programmable controller. Reference numeral 400 designates a communication channel. An external device 200 and the programmable displays 100a to 100n are connected together by way of the communication channel 400.

Reference numeral 500 designates drawing data generation means; namely, drawing software installed in a personal computer (hereinafter abbreviated as “PC”). The drawing data 112 are generated and changed by use of the drawing software 500. When the drawing data 112 are generated and changed by means of the drawing software 500, the drawing data 112 thus generated and changed are transferred to the programmable displays 100a to 100n by way of a communication channel newly set in the programmable displays 100a to 100n or a storage medium like a CF card, as necessary.

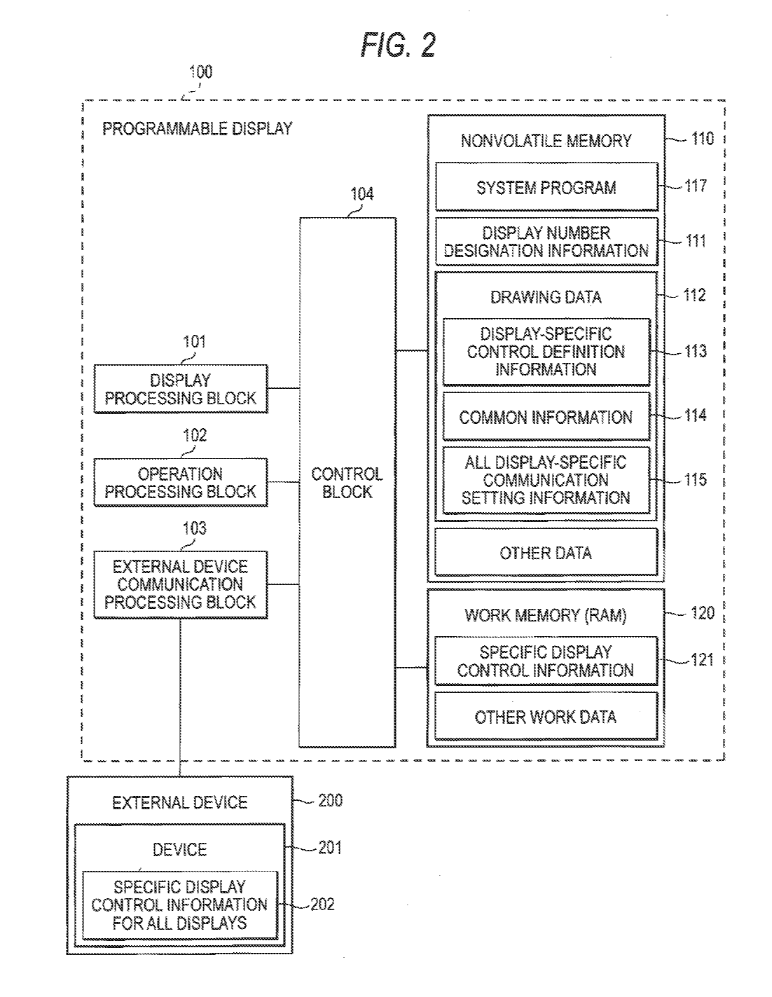

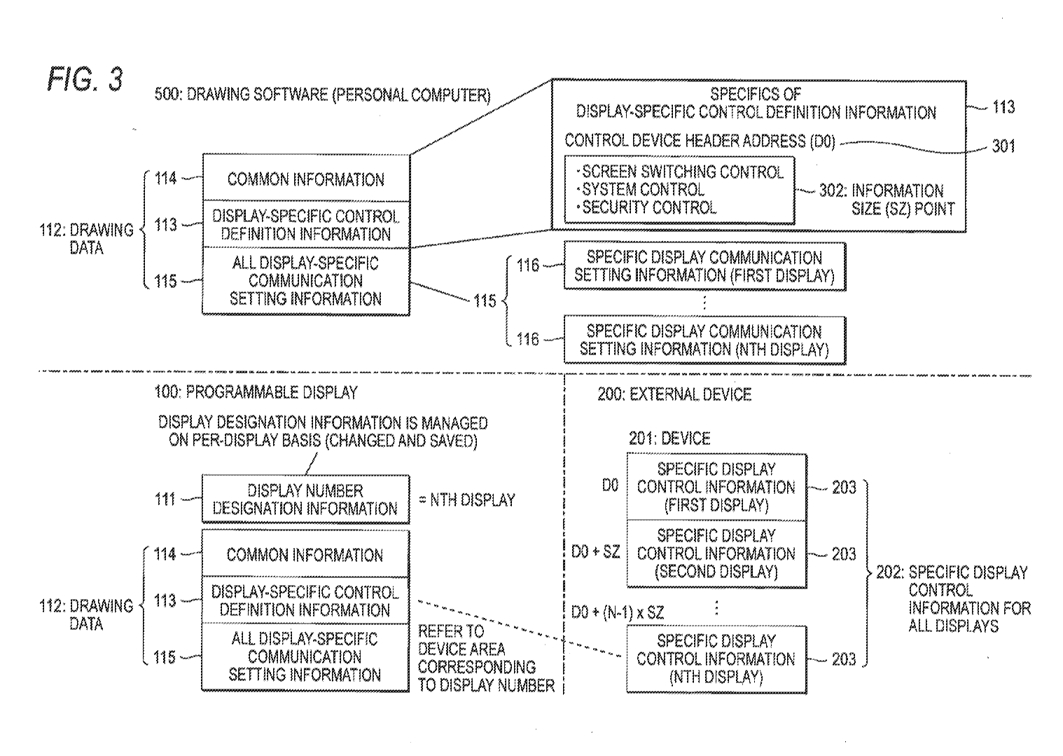

FIG. 2 is an internal block diagram of the programmable display of the first embodiment of the present invention. FIG. 3 is a block diagram of information handled by the control system configured of the plurality of programmable displays 100 of the first embodiment for implementing the present invention.

In FIG. 2, reference numeral 100 designates the programmable display, and 110 designates a first memory block; for instance, nonvolatile memory. Reference numeral 111 designates display designation information for specifying the programmable display 100. The display designation information 111 may be previously designated in advance with respect to each of the programmable displays 100. Alternatively, the display designation information 111 may also be designated by means of operator's input operation after start-up of the programmable display 100. The display designation information 111 can also be arbitrarily designated with respect to each of the programmable displays 100. For instance, the display designation information 111 can assign each of display numbers 1 to N to each of programmable displays 100a to 100n. Alternatively, a same display number N can be assigned to all of the programmable displays 100a to 100n.

The nonvolatile memory 110 has the display designation information 111, the drawing data 112, log data, and other data.

Reference numeral 113 designates display-specific control definition information that defines information for specifying a storage destination in the external device 200 where control information about the programmable display 100 is to be stored. Reference numeral 114 designates common information that defines screen settings common to all of the programmable displays 100. Reference numeral 115 designates all display-specific communication setting information for establishing communication with the external device 200. The all display-specific communication setting information 115 stores specific display communication setting information 116 for all of the displays, which are configured of IP addresses of the programmable displays 100 and the external devices 200.

The display designation information 111 for the programmable display 100 has been specified by means of input operation, or the like, from an operator. Subsequently, on the basis of the display designation information 111, settings necessary for communication with the external device 200 are made by reference to its specific display communication setting information 116 in the display-number-specific total communication indication information 115. The programmable display 100 can thereby establish communication with the external device 200. Reference numeral 117 designates a system program required to start up the programmable display 100.

Reference numeral 101 designates a display processing block that provides a screen display on the basis of the common information 114. Reference numeral 102 designates an operation processing block that detects input operation of the programmable display 100, including touch operation, performed by the operator and performs processing according to the common information 114 and specific display control information 121. Reference numeral 103 designates an external device communication processing section that establishes communication with the external device 200 according to the specific display communication setting information 116 and that reads or writes a value of a device 201, which is a first device, stored in the external device 200.

Reference numeral 104 designates a control block that control processing of the display processing block 101, processing of the operation processing block 102, and processing of the external device communication processing block 103. Reference numeral 120 designates a second memory block; that is work memory; for instance, RAM. Reference numeral 121 designates specific display control information for performing control operation according to each of the programmable displays 100. The work memory 120 stores the specific display control information 121, and other work data, for example, control information about the programmable display 100.

Reference numeral 201 designates the device that is a memory area for storing information about control of the external device 200 and that is configured of volatile memory. Reference numeral 203 designates specific display control information including control information about each of the programmable displays 100. Reference numeral 202 designates specific display control information for all displays, which is the specific display control information 203 of all of the programmable displays. The specific display control information for all displays 202 is stored in the device 201.

Operation of the programmable display is now described by reference to FIGS. 2 and 3. First, the drawing software 500 stored in the personal computer generates the drawing data 112 that is configured of the display-specific control definition information 113, the common information 114, and the all display-specific communication setting information 115. If necessary, the drawing data 112 are changed by the drawing software 500. The thus-generated, changed drawing data 112 are stored in the nonvolatile memory 110 in each of the programmable displays 100a to 100n.

The control block 104 displays a component, such as a switch and a lamp, on a screen by means of the display processing block 101, according to the common information 114. Further, the control block 104 controls the programmable displays 100 by way of the operation processing block 102 according to a result of detection of input operation performed by the operator. A switch, a lamp, or the like, displayed on the display processing block 101 is a component for providing a display commensurate with a state of the device 201 stored in the external device 200 and operating the device 201. The control block 104 reads and writes data from and to the device 201 stored in the external device 200 by way of the external device communication processing block 103 according to the specific display communication setting information 116.

In the display-specific control definition information 113, reference numeral 301 designates a control device header address (hereinafter also expressed as “DO”) that represents a header address in the device 201 of the external device 200. Reference numeral 302 designates an information size (hereinafter also expressed as “SZ”) that specifies a size (a device score) of an area where information required to control each of the programmable displays 100 is to be stored. The information size 302 corresponds to a total of control information required to control one programmable display 100, such as system control for controlling screen switching and behavior of the programmable display 100, security control for controlling operation or a display by means of an operator's authority, and the like.

When a display number defined by the display designation information 111 is taken as N, the information size 302 is continuous from SZ of display number 1 to SZ of display number N. Of the specific display control information for all displays 202 in the device 201 stored in the external device 200, the specific display control information 203 assigned to its programmable display takes an address computed by D0+(N−1)×SZ as a header and is present in numbers equal to an SZ score. The specific display control information 203 is stored in the device 201. The control device header address (D0) 301 and the information size (SZ) 302 are defined in the display-specific control definition information 113. By means of D0 and SZ defined by the display-specific control definition information 113 and N defined by the display designation information 111, there is calculated and specified a storage destination in the device 201 where the specific display control information 203 assigned to the specified programmable display 100 is stored.

According to the display designation information 111 and the display-specific control definition information 113, the control block 104 makes a reference to and reads the specific display control information 203 assigned to its programmable display among the specific display control information for all displays 202 by way of the external device communication processing block 103. When no information is in the specific display control information 121, such as a case that occurs immediately after startup of the programmable displays 100, the control block 104 stores the read the specific display control information 203 into the specific display control information 121. Subsequently, when a change is made to the display designation information 111 by means of the input operation made by the operator, the control block 104 synchronizes the specific display control information 121 to the specific display control information 203 assigned to the changed display designation information 111.

It is also possible to select, from the specific-display-number control information 203 assigned to its programmable display, only control information that the programmable display 100 desires to control. In this case, in a stage of generation of the drawing data 112, a list of all control objects stored in the specific display control information 203 is previously written in the display-specific control definition information 113. Objects to be controlled by the programmable display 100 designated by the display designation information 111 are selected from the list of all control objects, by means of checking or the like. The control block 104 stores in the specific display control information 121 only the control information that has been selected as control objects from the specific display control information 203 assigned to its programmable display, according to the display-specific control definition information 113 and the display designation information 111.

For instance, as shown in FIG. 3, screen switching control, system control, and security control are previously written as control information that are desired to be controlled, in the display-specific control definition information 113. The control block 104 stores, into the specific display control information 121, the screen switching control, system control, and security control of the specific display control information 203 assigned to its programmable display.

The control block 104 performs control operation, such as screen switching of the programmable display 100, according to the specific display control information 121. Further, the control block 104 writes information, such as a screen number being currently displayed and a security level, into the specific display control information 121 and the specific display control information 203.

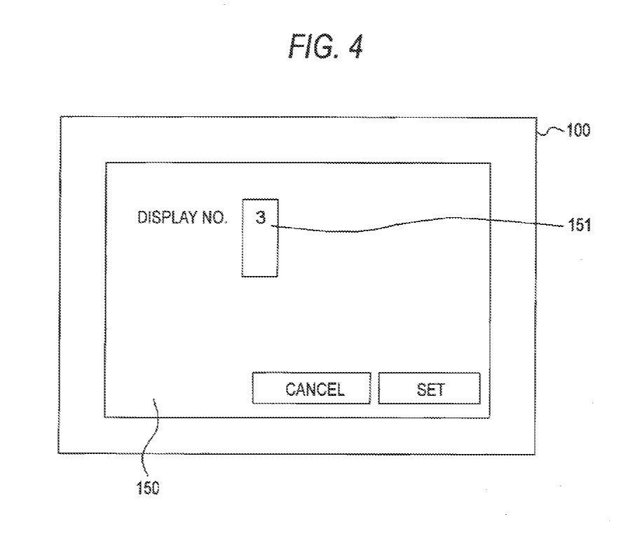

FIG. 4 is an example screen pertaining to a method for setting the display designation information 111 of the programmable display 100 described in connection with the first embodiment for implementing the invention. The display designation information 111 provides; for instance, a mechanism for setting in a display designation information entry field 151 in a display designation information setting screen 150 provided on the programmable display 100. For instance, the display designation information setting screen 150 may also be set so as to appear when objects appearing on a screen of the display processing block 101 are subjected to touch operation after startup of the system program 117 shown in FIG. 2. In accordance with a value input to the display designation information entry field 151, the programmable display 100 reads the specific display control information 203 assigned to itself; synchronizes the information to the specific display control information 121 and controls operation of the programmable display 100 itself, such as screen switching, system control, security control, and the like.

The specific display control information 203 can also be used as means for reporting the state of the programmable display 100 to the external device 200. For instance, the programmable display 100 can also write information, such as an identification number of an object, like a touch switch component that is in the course of input operation, touched coordinates, a currently-displayed screen, and a security condition, into the specific display control information 203.

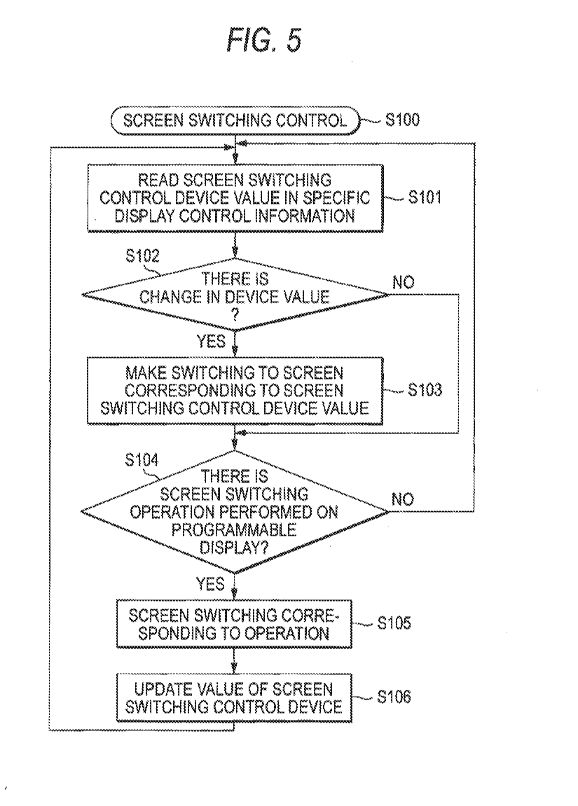

Processing is now described by means of taking, as an example, screen switching control of the programmable display 100. FIG. 5 shows processing procedures of screen switching control of the specific display control information 203 of the programmable display 100 of the first embodiment for implementing the present invention. First, the programmable display 100 reads a screen switching control device value stored in the specific display control information 121 synchronized to the specific display control information 203 (step S101). The screen switching control device value is a unique value assigned to each of the screens. The screen changes in accordance with the screen switching control device value.

It is checked whether or not a change has been made to the screen switching control device value (step S102). When the screen switching control device value includes the change (YES in step S102), screen switching to a screen commensurate with the screen switching control device value is made (step S103). Next, it is checked whether or not screen switching operation, such as actuation of a touch switch on the programmable display 100, has been made (step S104).

When no change has been made to the screen switching control device value (NO in step S102), processing proceeds to step S104 for checking whether or not screen switching operation has been made by means of a touch switch, or the like.

When screen switching operation is made (YES in step S104), switching of the screen to a screen commensurate with operation is made (step S105). Further, a screen switching control device value provided in the specific display control information 121 is updated to a value commensurate with the switched screen (step S106).

When update has been made to a value commensurate with the switched screen or when screen switching operation is not performed (NO in step S104), processing returns to S101.

In relation to the thus-configured programmable display 100, controlling or status monitoring of the programmable display 100 can be performed according to the specific display control information 121 synchronized to the specific display control information 203. Therefore, the external device 200 can monitor or control the programmable displays 100 independently. As a consequence, even when connected to the common external device 200 while having the same drawing data 112, the individual programmable displays 100 can operate independently.

According to the first embodiment of the present invention, the independent specific display control information 203 is allocated to each of the programmable displays 100 by means of the single drawing data 112 common to all of the programmable displays 100 making up the control system. Hence, there is no necessity for generating the drawing data 112 for each of the programmable displays 100. Further, a control system in which the external device 200 can independently control each of the programmable displays 100 can be established.

Further, the drawing data 112 for the plurality of programmable displays 100 can be commonly controlled. Therefore, even if a change has been made to the drawing data 112, the change can be addressed by means of simply modifying the single common drawing data 112 with the drawing software 500 stored in the personal computer and horizontally expanding the thus-modified, single common drawing data 112 to all of the programmable displays 100 by way of a communication channel or a memory medium, like a CF card. When compared with a related-art case where individual drawing data 112 are generated for each of the programmable displays 100, there is yielded an advantage of the ability to reduce the number of changing steps and prevent errors due to skipping of horizontal expansion of changes.

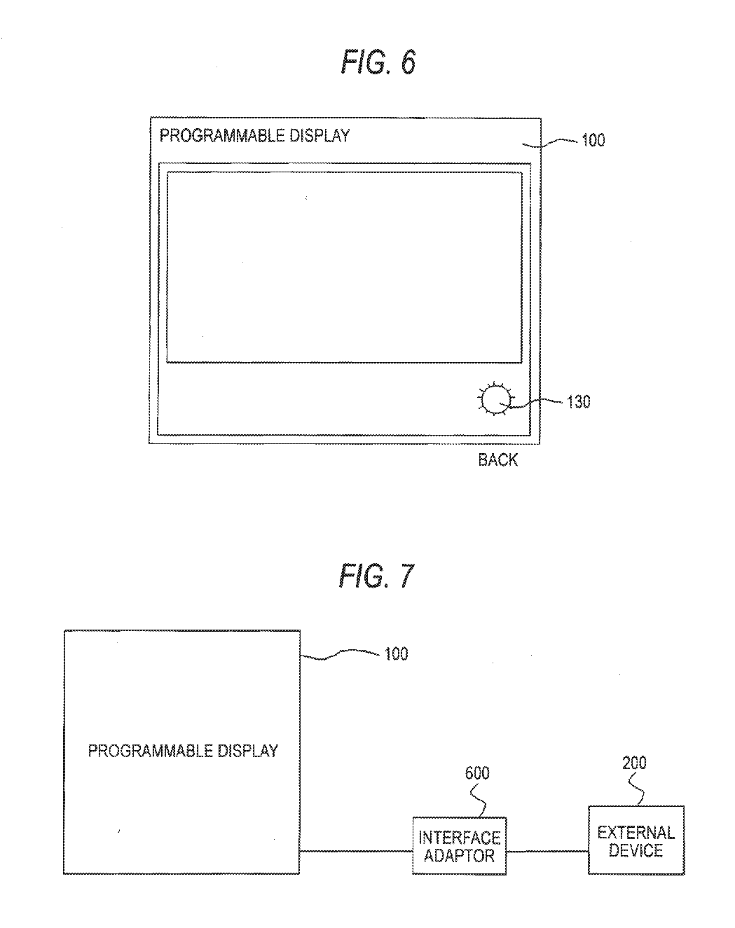

The configuration is an example of the first embodiment of the present invention, and the respective constituent elements, storage destinations of data, and memory mediums may also assume another form having equivalent features. For instance, as shown in FIG. 6, the display designation information 111 can be set by means of a rotary switch 130 provided on a back of the programmable display 100. Further, as shown in FIG. 7, it is also possible to cause a communication interface adaptor 600 to which the programmable display 100 is to be equipped to have the display designation information 111.

The first embodiment has explained the following case. Namely, the display-specific control definition information 113, the common information 114, and the all display-specific communication setting information 115 are stored in the drawing data 112 of the programmable display 100. An access is made to the device 201 in the external device 200 by use of the display designation information 111 and the drawing data 112 stored in the nonvolatile memory 110. The specific display control information 203 is specified by the control device header address 301 and the information size 302 stored in the display-specific control definition information 113. However, it is not limited to this case. It is also possible to define, in the display designation information 111, a display number, the control device header address 301, and the information size 302 for specifying the programmable display 100. The common information 114 and the all display-specific communication setting information 115 can be stored in the drawing data 112. The specific display control information 203 can be specified by means of the display designation information 111 and the drawing data 112 to which the information has been added.

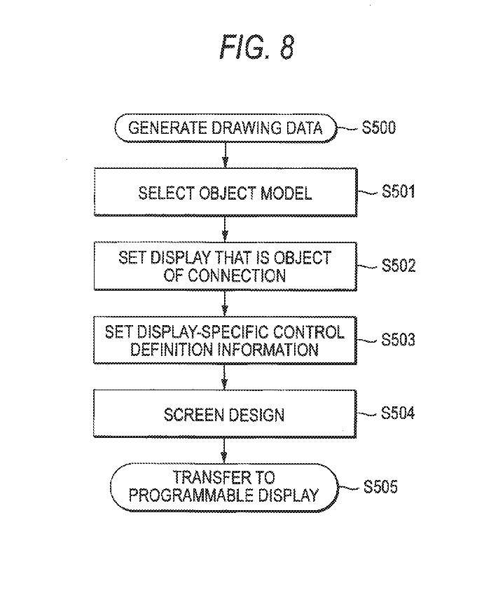

Procedures for generating the drawing data 112 in the first embodiment of the present invention are now described by reference to FIG. 8. The drawing data 112 are generated by letting the drawing software 500, which is drawing data generation means, run on the personal computer. First, the personal computer starts up. At the time of initiation of generation of drawing data after startup of the drawing software 500 (step S500), a model, such as a type of the programmable display 100 that is to be an objective, is selected (step S501).

The external device 200 that is to be an objective of connection is next set (step S502). In step S502, there is set the all display-specific communication setting information 115 that is, the specific display communication setting information 116 for all of the programmable displays, which are necessary for establishing a connection with the external device 200, like the type of the external device 200, the connection method, and the like.

Next, the display-specific control definition information 113 is set (step S503). There is set the common information 114 that designs a common screen, such as various setting operations for letting all of the programmable displays 100 perform displaying, operation, and controlling, according to the type of the programmable displays 100 selected in step S501 (step S504). The sequence of the settings is not fixed, and the information that has already been set can also be changed later as necessary.

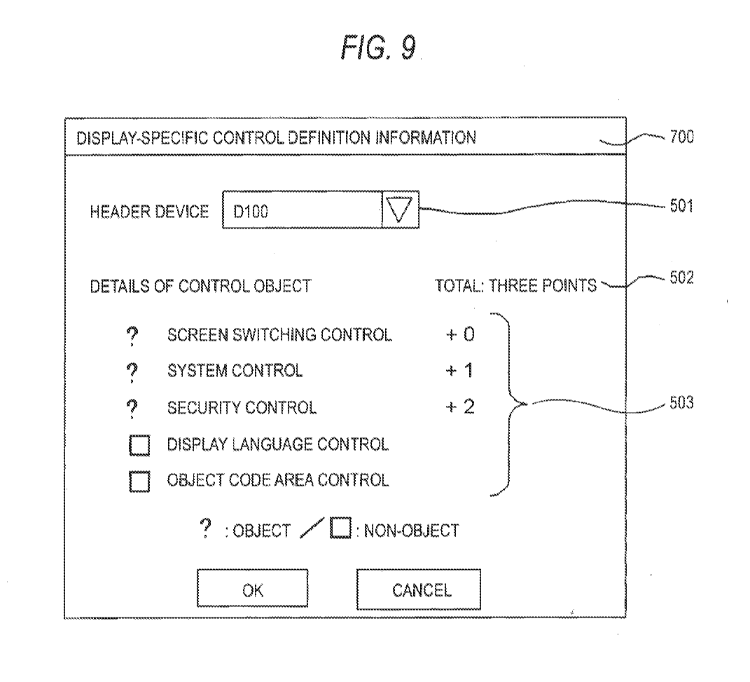

Next, in relation to setting of the display-specific control definition information 113 in step S503, a setting screen 700, such as that shown in, for instance, FIG. 9, is generated as one function of the drawing software 500. The setting screen 700 has a header device input field 501 where the control device header address 301 is input, a control object information selection field 503 by means of which a control object is selected from the display-specific control definition information 113, and an information size display field 502 that is a display field of the information size 302 showing a total size of control object information.

The control object information selection field 503 displays a list of candidates for information by means of which the external device 200 controls the programmable displays 100 and information by means of which statuses of the programmable displays 100 are written into the device 201 stored in the external device 200. It is possible to select whether or not to take the pieces of information as an objective in the form of a desired combination according to a system created by the operator. The information size 302 that is a total of information taken as a control object in the control object information selection field 503 is displayed in the information size display field 502. Although the present embodiment shows a case in which details of the display-specific control definition information 113 are designated by means of a desired combination after determination of the display designation information 111, it is also possible to set only the information size 302 of the display-specific control definition information 113 and designate by the information size 302 and the control device header address 301.

Details of the display-specific control definition information 113 includes information, like screen switching control for controlling a screen taken as a display object; system control for controlling a system of the programmable display 100 like screen-saving or buzzer sounds, security control for controlling authority of operation and screen browsing, and the like.

### Second Embodiment

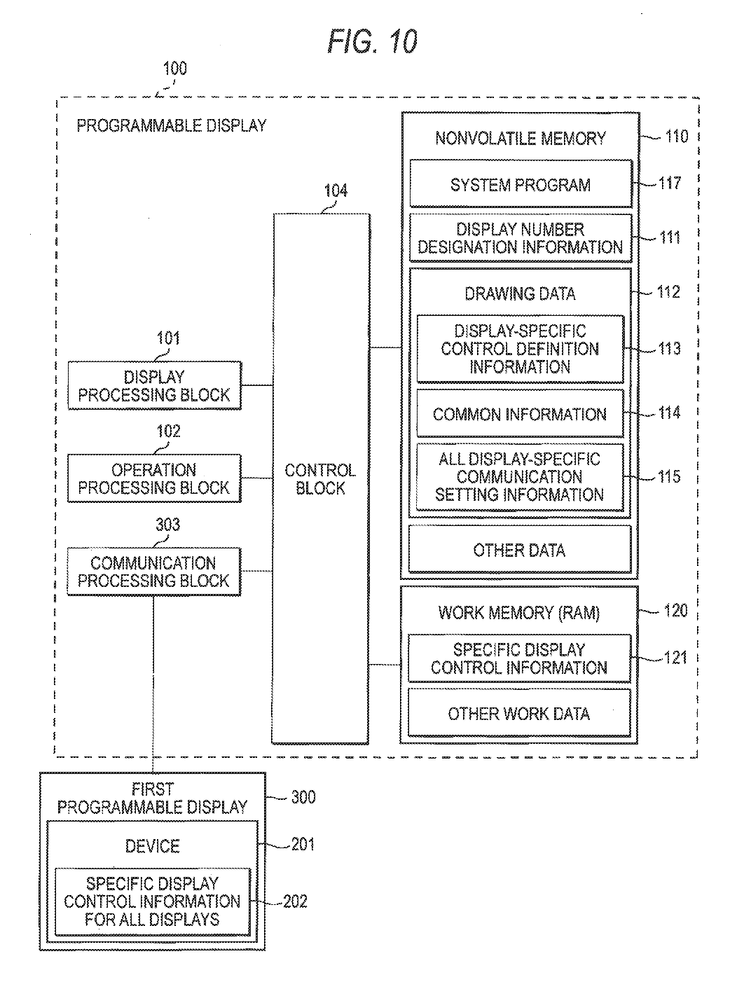

The first embodiment has described a case where the device 201, which is the first device, is stored in the external device 200. However, the present invention does not need to be limited to a configuration in which the device 201 is stored in the external device 200. As shown in FIG. 10, a similar advantage can be yielded even when the device 201 is stored as a second device in one specific first programmable display 300 among a plurality of programmable displays.

In the second embodiment, a communication processing block 303 is provided in the programmable display 100 that is a second programmable display. The control block 104 reads and writes data from and into the device 201 stored in the first programmable display 300 by way of the communication processing block 303 on the basis of a definition of the specific display communication setting information 116 assigned to its programmable display in the all display-specific communication setting information 115. Since the subsequent control procedures are the same as those described in connection with the first embodiment, they are omitted here for brevity.

### DESCRIPTIONS OF THE REFERENCE NUMERALS AND SYMBOLS

100 PROGRAMMABLE DISPLAY,
103 EXTERNAL DEVICE COMMUNICATION PROCESSING BLOCK,
104 CONTROL BLOCK,
110 NONVOLATILE MEMORY,
111 DISPLAY DESIGNATION INFORMATION,
112 DRAWING DATA,
113 DISPLAY-SPECIFIC CONTROL DEFINITION INFORMATION,
115 ALL DISPLAY-SPECIFIC COMMUNICATION SETTING INFORMATION,
116 SPECIFIC DISPLAY COMMUNICATION SETTING INFORMATION,
120 WORK MEMORY,
200 EXTERNAL DEVICE,
201 DEVICE,
202 SPECIFIC DISPLAY CONTROL INFORMATION FOR ALL DISPLAYS,
203 SPECIFIC DISPLAY CONTROL INFORMATION

1. A control system including,
a programmable display, and
an external device that is connected to the programmable display by way of a communication channel and the programmable display reads and writes information from and in the external device,
wherein the external device stores specific display control information, which is control information for controlling the programmable display, into a first device for each display designation information, in correspondence with the display designation information for specifying the programmable display connected to the communication channel; and
wherein the programmable display includes
a first memory block that stores the display designation information and all display-specific communication setting information for establishing a communication with the external device, and
a control block that makes an access to the first device of the external device according to the display designation information and the all display-specific communication setting information, to thus acquire its specific display control information corresponding to the display designation information, that stores the acquired specific display control information into a second memory block, and that controls the programmable display according to the specific display control information stored in the second memory block.

2. The control system according to claim 1, wherein the programmable display includes,
the first memory block that stores display-specific control definition information which defines a storage destination of the specific display control information for each display designation information stored in the first device as well as the display designation information and the all display-specific communication setting information, and
the control block that makes an access to the first device of the external device according to the display designation information, the all display-specific communication setting information, and the display-specific control definition information, to thus acquire its specific display control information corresponding to the display designation information, that stores the acquired specific display control information into the second memory block, and that controls the programmable display according to the specific display control information stored in the second memory block.

3. A control system including,
a programmable display, and
an external device that is connected to the programmable display by way of a communication channel and the programmable display reads and writes information from and in the external device,
wherein the programmable display includes,
a first programmable display that stores in a second device, for each display designation information, specific display control information, which is control information for controlling the programmable display, in correspondence with the display designation information for specifying the programmable display connected to the communication channel, and
a second programmable display that acquires from the first programmable display its specific display control information; and
wherein the second programmable display includes,
a first memory block that stores the display designation information and all display-specific communication setting information for establishing a communication with the first programmable display, and
a control block that makes an access to the second device of the first programmable display according to the display designation information and the all display-specific communication setting information, to thus acquire its specific display control information corresponding to the display designation information, that stores the acquired specific display control information into a second memory block, and that controls the programmable display according to the specific display control information stored in the second memory block.

4. The control system according to claim 3, wherein the second programmable display includes,
the first memory block that stores display-specific control definition information which defines a storage destination of the specific display control information for each display designation information stored in the second device as well as the display designation information and the all display-specific communication setting information, and
the control block that makes an access to the second device of the first programmable display according to the display designation information, the all display-specific communication setting information, and the display-specific control definition information, to thus acquire its specific display control information corresponding to the display designation information, that stores the acquired specific display control information into the second memory block, and that controls the programmable display according to the specific display control information stored in the second memory block.

5. The control system equipped with the programmable display defined in claim 2,
wherein the display-specific control definition information includes
a header address of the first device or the second device where the specific display control information of the programmable display is stored, and
an information size occupied by the specific display control information assigned to the programmable display; and
wherein the storage destination of the specific display control information in the first device or the second device is specified by the display designation information and the display-specific control definition information.

6. The control system equipped with the programmable display defined in claim 5,
wherein the display-specific control definition information includes control information selected from the specific display control information in addition to the header address and the information size, and
wherein the storage destination of the specific display control information in the first device or the second device is specified by the display designation information and the display-specific control definition information, and the control information is specified from among the specific display control information.

7. A programmable display connected to an external device and that reads or writes information from or to the external device by way of a communication channel, the external device stores in a first device specific display control information, which is control information for controlling the programmable display, for each display designation information, in correspondence to the display designation information for specifying the programmable display connected to the communication channel,
wherein the programmable display includes
a first memory block that stores the display designation information and all display-specific communication setting information for establishing a communication with the external device, and
a control block that makes an access to the first device of the external device according to the display designation information and the all display-specific communication setting information, to thus acquire its specific display control information corresponding to the display designation information, that stores the acquired specific display control information into a second memory block, and that controls the programmable display according to the specific display control information stored in the second memory block.

8. The programmable display according to claim 7, wherein the programmable display includes
the first memory block that stores display-specific control definition information which defines a storage destination of the specific display control information for each display designation information stored in the first device as well as the display designation information and the all display-specific communication setting information, and
the control block that makes an access to the first device of the external device according to the display designation information, the all display-specific communication setting information, and the display-specific control definition information, to thus acquire its specific display control information corresponding to the display designation information, that stores the acquired specific display control information into the second memory block, and that controls the programmable display according to the specific display control information stored in the second memory block.

9. A programmable display connected, by way of a communication channel, to an external device and reads and writes information from and in the external device,
wherein the programmable display includes,
a first programmable display that stores in a second device, for each display designation information, specific display control information, which is control information for controlling the programmable display, in correspondence with the display designation information for specifying the programmable display connected to the communication channel, and
a second programmable display that acquires from the first programmable display its specific display control information; and
wherein the second programmable display includes
a first memory block that stores the display designation information and all display-specific communication setting information for establishing a communication with the first programmable display, and
a control block that makes an access to the second device of the first programmable display according to the display designation information and the all display-specific communication setting information, to thus acquire its specific display control information corresponding to the display designation information, that stores the acquired specific display control information into a second memory block, and that controls the programmable displays according to the specific display control information stored in the second memory block.

10. The programmable display according to claim 9, wherein the second programmable display includes
the first memory block that stores display-specific control definition information which defines a storage destination of the specific display control information for each display designation information stored in the second device as well as the display designation information and the all display-specific communication setting information, and
the control block that makes an access to the second device of the first programmable display according to the display designation information, the all display-specific communication setting information, and the display-specific control definition information, to thus acquire the specific display control information corresponding to the display designation information, that stores the acquired specific display control information into the second memory block, and that controls the programmable display according to the specific display control information stored in the second memory block.

11. The programmable display defined in claim 8,
wherein the display-specific control definition information includes,
a header address of the first device or the second device where the specific display control information of the programmable displays is stored, and
an information size occupied by the specific display control information assigned to the programmable display; and
wherein the storage destination of the specific display control information in the first device or the second device is specified by the display designation information and the display-specific control definition information.

12. The programmable display defined in claim 11,
wherein the display-specific control definition information includes control information selected from the specific display control information in addition to the header address and the information size, and
wherein the storage destination of the specific display control information in the first device or the second device is specified by the display designation information and the display-specific control definition information, and the control information is specified from among the specific display control information.

13. Drawing data generation means for generating drawing data that define operation of a programmable display, wherein the means causes a computer to execute:
a processing for setting all display-specific communication setting information used when the programmable display establish a communication with an external device that is connected to the programmable display by way of a communication channel, the programmable display reading or writing information from or to the external device, and the external device storing in a first device specific display control information, which is control information for controlling the programmable display, for each display designation information, in correspondence with the display designation information for specifying the programmable display connected to the communication channel;
a processing for setting display-specific control definition information which defines a storage destination of the specific display control information for each display designation information stored in the first device; and
a processing for setting common information for defining a screen design common to the programmable display.

14. Drawing data generation means for generating drawing data that define operation of a programmable display, wherein the means causes a computer to execute:
a processing for setting all display-specific communication setting information used for establishing a communication between a first programmable display that stores in a second device, for each display designation information, specific display control information, which is control information for controlling the programmable display, in correspondence with the display designation information for specifying the programmable display connected to the communication channel and a second programmable display that acquires its specific display control information from the first programmable display, among the programmable display connected by way of a communication channel to an external device, the programmable display reading and writing information from and to the external device;
a processing for setting display-specific control definition information which defines a storage destination of the specific display control information for each display designation information stored in the second device; and
a processing for setting common information for defining a screen design common to the programmable displays.

15. The drawing data generation means according to claim 13,
wherein the processing for setting the display-specific control definition information is a processing for setting:
a header address of the first device or the second device where the specific display control information of the programmable displays is stored; and
an information size occupied by the specific display control information assigned to the programmable display.

16. The drawing data generation means according to claim 15,
wherein the processing for setting the display-specific control definition information is a processing for setting the header address and the information size and control information selected from the specific display control information.
